(19) United States
(12) Patent Application Publication
(10) Pub. No.: US 2011/0314498 A1
(43) Pub. Date: Dec. 22, 2011

(54) TELEVISION APPARATUS AND CONTROLLING METHOD THEREOF

(75) Inventor: Lukasz WINIARSKI, Piwniczna (PL)

(73) Assignee: SAMSUNG ELECTRONICS CO., LTD., Suwon-si (KR)

(21) Appl. No.: 13/166,366

(22) Filed: Jun. 22, 2011

(30) Foreign Application Priority Data
Jun. 22, 2010 (KR) 10-2010-0059026

(51) Int. Cl. H04N 5/445

(52) U.S. Cl. 725/38

(57) ABSTRACT

A television apparatus and a controlling method thereof are provided. The television apparatus includes an interface unit which is connected to an external apparatus in which multimedia data is stored, an output unit which reproduces the multimedia data provided from the external apparatus and outputs the multimedia data, and a controller which, if a pre-set event occurs, controls the output unit to output description information regarding the multimedia data along with the multimedia data. Therefore, the television device provides description information regarding multimedia data and thus a user does not have to explain about the multimedia data.

### CROSS-REFERENCE TO RELATED APPLICATIONS

This application claims priority from Korean Patent Application No. 2010-59026, filed in the Korean Intellectual Property Office on Jun. 22, 2010, the disclosure of which is incorporated herein by reference.

### BACKGROUND

1. Field

Apparatuses and methods consistent with the exemplary embodiments relate to a television apparatus and a controlling method thereof, and more particularly, to a television apparatus which provides information regarding multimedia data and a controlling method thereof.

2. Description of the Related Art

Generally, a Universal Serial Bus (USB) connector is installed in an apparatus such as a computer. In recent years, however, televisions have been developed which have an internal USB connector so that contents in the USB apparatus can be read and reproduced on the television.

Accordingly, the television may have a photo browser to search and browse photos stored in a USB apparatus.

Therefore, many people often invite their friends over to their house to show photos on their television by executing a photo browser in the television. However, the photo browser of the television may only search photos and display the searched photos on the screen, and does not provide any description information regarding the photos. Therefore, the owner of the photos would have to verbally describe the story related to the photos.

If the owner has difficulty remembering when, where, and how a photo was taken, it is very difficult to provide description information regarding the photo. Therefore, people usually make a file name of a photo which includes description information regarding the photo.

Therefore, if a user does not remember a story involving a photo, the user would have to check the file name of the photo on a computer.

If a user invites people over to his or her house to show photos, the user would have to check the file name of the photos and then explain the story related to the photos themselves, and this may cause inconvenience.

### SUMMARY

Aspects of the exemplary embodiments relate to a television apparatus which may provide description information regarding multimedia data and a method for controlling the television apparatus thereof.

A television apparatus, according to an exemplary embodiment, includes an interface unit which is connected to an external apparatus in which multimedia data is stored, an output unit which reproduces the multimedia data provided from the external apparatus and outputs the multimedia data, and a controller which, if a pre-set event occurs, controls the output unit to output description information regarding the multimedia data along with the multimedia data.

The output unit may include a display unit which displays the multimedia data on the screen and a speaker which outputs the description information in a form of sound data.

The output unit may include a display unit sync which displays the multimedia data on the screen and an on screen display (OSD) unit which forms the description information in a form of text and lets the text be displayed and moved on the screen.

The multimedia data may be a photo or a video, and the external apparatus may be a USB apparatus which is connected to the television apparatus or an image capturing apparatus which takes the photo data or the video data.

The description information may include at least one of information regarding a place where the photo or the video was taken, the name of the photo data or the video data, and recorded information regarding the photo data or the video data.

The apparatus may further include a storage unit which stores a multimedia data list or description information regarding the multimedia data provided by the external apparatus, and the controller, if at least one multimedia data is selected from the list, may receive the selected multimedia data from the external apparatus and provide the selected multimedia data to the output unit, and if the event occurs, read out description information corresponding to the selected multimedia data from among description information stored in the storage unit and provide the description information to the output unit.

The event may include at least one of a first event where a command to reproduce the multimedia data is input, a second event where a predetermined time elapses while the multimedia data is being reproduced, and a third event where a command to confirm output of description information is input while the multimedia data is being output on a screen.

The controller may control the output unit to display a window which provides description information and allows a user to select a function to output the description information.

The controller may output the description information in a form of sound data using text to speech (TTS) software.

A method for controlling a television apparatus, according to an exemplary embodiment, includes selecting multimedia data provided by an external apparatus, and if a pre-set event occurs, outputting description information regarding the multimedia data along with the multimedia data.

Outputting of the description information may include outputting the multimedia data on the screen and outputting the description information in a form of sound data.

The outputting the description information may include outputting the multimedia data on the screen and forming the description information in a form of text and letting the description information be displayed and moved on the screen.

The multimedia data may be a photo or a video, and the external apparatus may be a USB apparatus which is connected to the television apparatus or an image capturing apparatus which takes the photo data or the video data.

The description information may include at least one of information regarding a place where the photo or the video was taken, the name of the photo data or the video data, and recorded information regarding the photo data or the video data.

The method may further include storing a multimedia data list and description information regarding the multimedia data provided by the external apparatus after the multimedia data is selected, and outputting of the description information may include, if at least one multimedia data is selected from the list, receiving the selected multimedia data from the external apparatus and outputting the multimedia data, and if the event occurs, reading out description information corresponding to the selected multimedia data from among the stored description information and outputting the description information.

The event may include at least one of a first event where a command to reproduce the multimedia data is input, a second event where a predetermined time elapses while the multimedia data is being reproduced, and a third event where a command to confirm output of description information is input while the multimedia data is being output on the screen.

Outputting of the description information may include displaying a window which provides description information and allows a user to select a function to output the description information.

Outputting of the description information may include outputting the description information in a form of sound data using text to speech (TTS) software.

According to various exemplary embodiments, description information regarding multimedia data may be provided easily.

### BRIEF DESCRIPTION OF THE DRAWINGS

The above and/or other aspects of the present disclosure will be more apparent and more readily appreciated from the following description of the exemplary embodiments, taken in conjunction with the accompanying drawings, in which:

FIG. 1 is a schematic block diagram of a television apparatus according to an exemplary embodiment;

FIGS. 2A and 2B are views illustrating windows which allow a user to select a description information providing mode while operating a television apparatus according to an exemplary embodiment;

FIG. 3 is a view illustrating an example of description information provided in a form of text on a television apparatus according to an exemplary embodiment; and

FIG. 4 is a flowchart illustrating a method for controlling a television apparatus according to an exemplary embodiment.

### DETAILED DESCRIPTION OF THE EXEMPLARY EMBODIMENTS

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

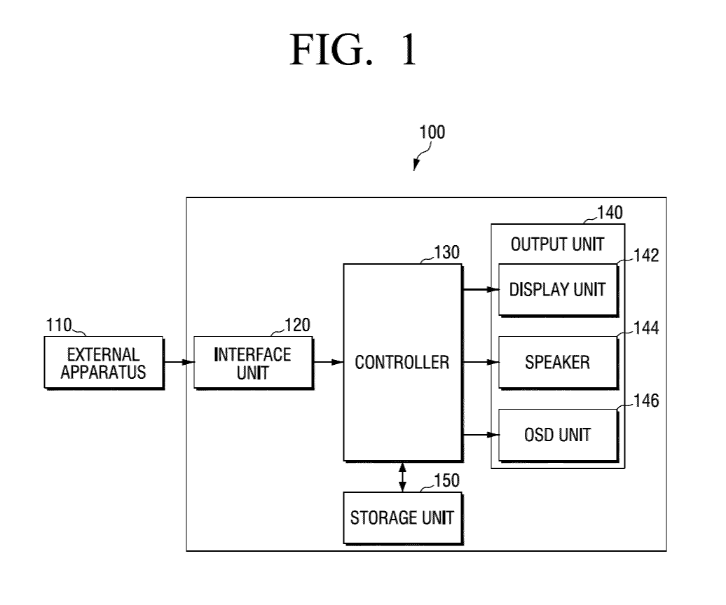

FIG. 1 is a schematic block diagram of a television apparatus according to an exemplary embodiment. As illustrated in FIG. 1, the television apparatus 100 comprises an interface unit 120, a controller 130, an output unit 140, and a storage unit 150. The television apparatus 100 may be connected to an external apparatus 110 which stores multimedia data.

The television apparatus 100 may be a television including a tuner (not shown) which can receive a broadcast signal or a display apparatus such as an electronic album which can display at least one photograph.

Herein, the external apparatus 110 connected to the television apparatus 100 stores multimedia data. The external apparatus 110 may be any apparatuses including a USB memory which can be connected through a USB cable and may be an image capturing apparatus which takes a photo or video.

The multimedia data may be photos or video data such as a photo file or a video file, but the multimedia data is not limited thereto. The multimedia data may include various types of multimedia data including a PDF file, a Power-Point file, and an Excel file.

The interface unit 120 connects the external apparatus 110, in which multimedia data is stored, with the television apparatus 100 by supporting interface between a television apparatus and the external apparatus 110.

If a pre-set event occurs, the controller 130 controls the output unit 140 to output multimedia data along with description information regarding the multimedia data.

In an exemplary embodiment, the pre-set event may include at least one of a first event where a command to reproduce multimedia data is input, a second event where a predetermined time elapses while multimedia data is being reproduced, and a third event where a command to confirm output of description information is input while multimedia data is being output on the screen.

In other words, if a function to provide description information is selected, the controller of the television apparatus, according to an exemplary embodiment, controls the output unit to output description information regarding multimedia data only when the event where a command to reproduce multimedia data is input, the event where a predetermined time elapses while multimedia data is being reproduced, and the event where a command to confirm description data is input while multimedia data is being output on the screen occur.

In an exemplary embodiment, the controller 130 controls the output unit 140 to display a window which provides description information and allows a user to select a function to output description information. In other words, a description information providing window is displayed to receive confirmation of the outputting of the description information, which is the third event mentioned above.

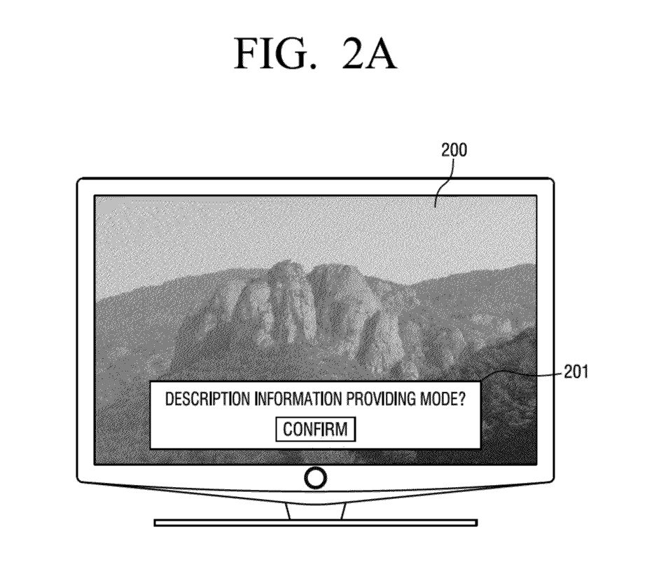

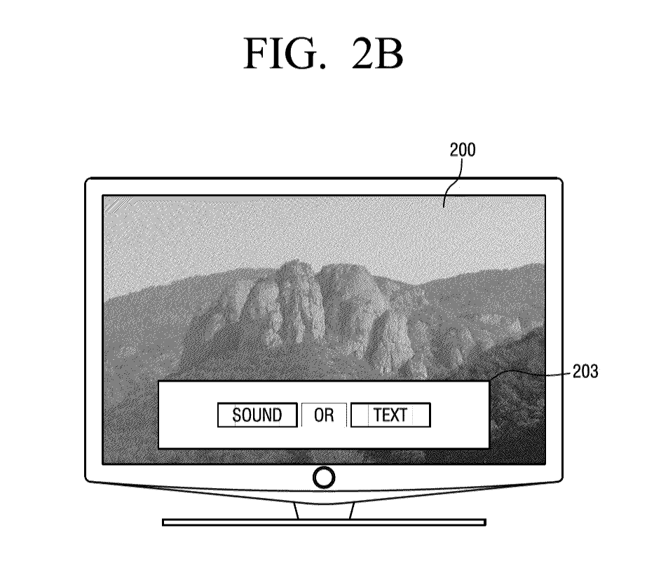

FIGS. 2A and 2B are views illustrating windows which allow a user to select a description information providing mode while operating a television apparatus according to an exemplary embodiment.

As illustrated in FIG. 2A, a window 201 which allows a user to select “a description information providing mode” regarding a photo 200 may be displayed. As illustrated in FIG. 2B, if “the description information providing mode” is selected by the user, a window 203 which allows the user to select an output type of description information between “sound” or “text” may be displayed.

The description information may include at least one of properties information such as a location where photo data or video data was taken, a file name including a photo data or video data name, and a separate file including recorded information where information regarding photo data or video data is recorded.

Referring back to FIG. 1, the storage unit 150 may include a multimedia data list or description information regarding multimedia data provided by the external apparatus 110.

Herein, if at least one multimedia data is selected from the list, the controller 130 receives the selected multimedia data from the external apparatus 110 and provides the data to the output unit 140. If an event occurs, the controller 130 reads out description information corresponding to the selected multimedia data from among description information stored in the storage unit 150 and provides the description information to the output unit 140.

The television apparatus, according to an exemplary embodiment, reads out description information of a photo from a file name of multimedia data, properties information such as a location of photographing, or a separate file where an explanation regarding the photo is recorded, and provides the description information after converting the information into sound data through text to speech (TTS) conversion. As the description information regarding the photo which is being reproduced on the television is automatically provided, the owner of the photo does not need to explain about the photo. Therefore, user convenience may be enhanced.

In an exemplary embodiment, the controller 130 controls the output unit 140 to output description information in the form of sound data using TTS software.

Herein, TTS is a widely known technology that converts text or symbol into sound and outputs the converted data. Detailed description information regarding TTS will not be provided. Since TTS software is available in various languages, the television apparatus, according to an exemplary embodiment, may convert description information into various languages. Therefore, the television apparatus may be used worldwide.

The output unit 140 reproduces multimedia data provided by an external apparatus and outputs the data on the screen. As illustrated in FIG. 1, the output unit 140 comprises a display unit 142, a speaker 144, and an on screen display (OSD) unit 146.

The display unit 142 displays multimedia data on the screen.

For example, the display unit 142 may include a liquid crystal display (LCD), a plasma display panel (PDP), a monochrome display, a color graphics adapter (CGA) display, an enhanced graphics adapter (EGA) display, a variable graphics adapter (VGA) display, a super-VGA display, and a cathode ray tube (CRT).

The speaker 144 outputs description information regarding multimedia data as sound data. In other words, the speaker 144 outputs description information which is converted into sound data through TTS software that is executed in the controller 130.

The OSD unit 146 forms description information regarding multi-media data in the form of text and lets the text be displayed and moved on the screen.

The text may be displayed on various locations of the screen such as up, down, left, or right of the screen, and may be displayed in various forms, for example, inside a bounding box. In addition, the text may be displayed in various languages just like the sound data.

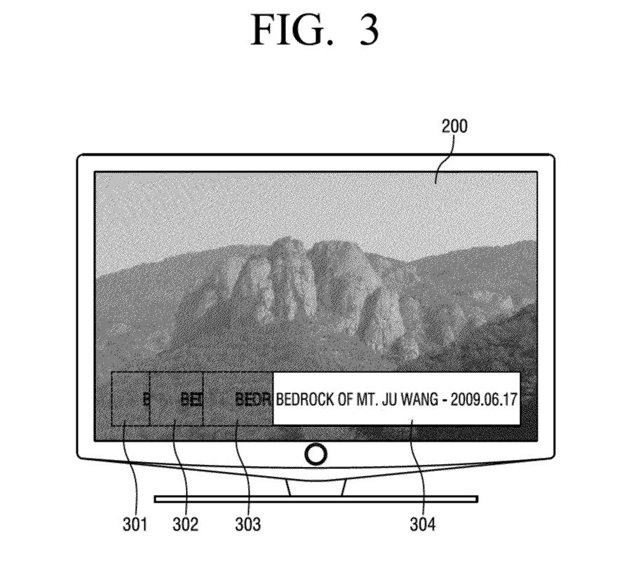

FIG. 3 is a view illustrating an example of description information provided in a form of text on a television apparatus according to an exemplary embodiment.

As illustrated in FIG. 3, a photo 200 was taken in “the bedrock of Mt. Ju Wang” on Jun. 17, 2009, and the text 301, 302, 303, 304 which provides description information regarding the photo, that is, where and when the photo was taken, is moved and displayed on the photo.

Referring back to FIG. 1, the storage unit 150 stores a multimedia data list and description information regarding multimedia data received from the external apparatus 110.

In other words, the television apparatus, according to an exemplary embodiment, does not obtain a multimedia data list and description information regarding multimedia data directly from the external apparatus 110. Instead, the television apparatus stores a multimedia data list and description information regarding multimedia data in the storage unit 150 and uses the stored list and description information regarding multimedia data later.

If at least one multimedia data is selected from the list, the controller 130 receives the selected multimedia data from the external apparatus 110 and provides the selected multimedia data to the output unit 140. If a pre-set event occurs, the controller 130 reads out description information corresponding to the selected multimedia data from among description information stored in the storage unit 150 and provides the description information to the output unit 140.

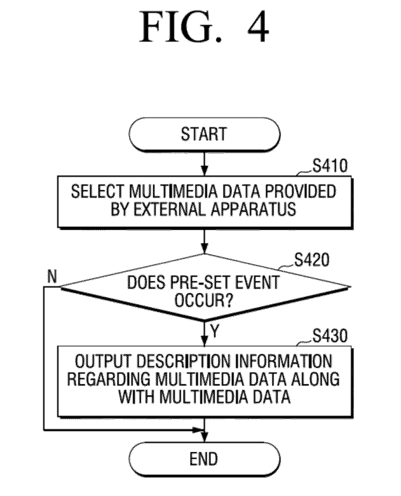

Hereinafter, a displaying method according to an exemplary embodiment will be explained with reference to FIG. 4.

First of all, multimedia data provided from an external apparatus is selected (operation S410).

Herein, the multimedia data may be photos or video data such as a photo file or a video file, but the multimedia data is not limited thereto. The multimedia data may include various types of multimedia data including a PDF file, a Power-Point file, and an Excel file.

In addition, an external apparatus stores multimedia data, and the external apparatus may be any apparatuses including a USB memory which can be connected through a USB cable and may be an image capturing apparatus which takes a photo or video.

After multimedia data is selected (operation S410), a multimedia data list and description information regarding the multimedia data provided from an external apparatus can be stored.

Subsequently, if a description information providing function is selected, it is determined whether a pre-set event occurs (operation S420).

Herein, the pre-set event may include at least one of a first event where a command to reproduce multimedia data is input, a second event where a predetermined time elapses while multimedia data is being reproduced, and a third event where a command to confirm output of description information is input while multimedia data is being output on the screen.

In an exemplary embodiment, a description information providing window which allows a user to select a function to output description information is displayed. Whether the third event occurs or not, that is, whether a command to confirm output of description information is input or not may be determined based on whether a description information providing function is selected or not.

The description information may include at least one of properties information such as a location where photo data or video data was taken, a file name including a photo data or video data name, and a separate file including recorded information where information regarding photo data or video data is recorded.

Lastly, if a pre-set event occurs, description information regarding multimedia data is output along with multimedia data. (operation S430).

According to an exemplary embodiment, in the step of outputting description information (operation S430), multimedia data is output on the screen, and the description information may be output in the form of sound data.

In the step of outputting description information (operation S430), description information may be output in the form of sound data using TTS software. Since the TTS software is available in various languages, the television apparatus, according to an exemplary embodiment, may convert description information into various languages. Therefore, the television apparatus may be used worldwide.

According to another exemplary embodiment, in the step of outputting description information (operation S430), multimedia data is output on the screen, and description information regarding multi-media data may be formed in text which is displayed and moved on the screen.

The text may be displayed on various locations of the screen such as up, down, left, or right of the screen, and may be displayed in various forms, for example, inside a bounding box. In addition, the text may be displayed in various languages just like sound data.

According to an exemplary embodiment, in the step of outputting description information (operation S430), if at least one multimedia data is selected from a stored list, the selected multimedia data is received from an external apparatus and is output.

In the step of outputting description information (operation S430), if a pre-set event occurs, description information corresponding to the selected multimedia data from among stored description information is extracted and output.

Although a few exemplary embodiments have been shown and described, it would be appreciated by those skilled in the art that changes may be made in the exemplary embodiments without departing from the principles and spirit of the exemplary embodiments, the scope of which is defined in the claims and their equivalents.

What is claimed is:

1. A television apparatus, comprising:
an interface unit which is connected to an external apparatus in which multimedia data is stored, and which receives the multimedia data from the external apparatus;
an output unit which reproduces the multimedia data provided from the external apparatus and outputs the multimedia data on a screen; and
a controller which, if a pre-set event occurs, controls the output unit to output description information regarding the multimedia data along with the multimedia data.

2. The apparatus as claimed in claim 1, wherein the output unit comprises:
a display unit which displays the multimedia data on the screen; and
a speaker which outputs the description information in a form of sound data.

3. The apparatus as claimed in claim 1, wherein the output unit comprises:
a display unit which displays the multimedia data on the screen; and
an on screen display (OSD) unit which forms the description information in a form of text and lets the text be displayed and moved on the screen.

4. The apparatus as claimed in claim 1, wherein the multimedia data is at least one of photo data and video data,
wherein the external apparatus is at least one of a Universal Serial Bus (USB) apparatus which is connected to the television apparatus and an image capturing apparatus which takes the photo data or the video data.

5. The apparatus as claimed in claim 4, wherein the description information includes at least one of information regarding a place where the photo data or the video data was taken, the name of the photo data or the video data, and recorded information regarding the photo data or the video data.

6. The apparatus as claimed in claim 1, further comprising:
a storage unit which stores a multimedia data list or description information regarding the multimedia data provided by the external apparatus,
wherein the controller, if at least one multimedia data is selected from the list, receives the selected multimedia data from the external apparatus and provides the selected multimedia data to the output unit, and if the pre-set event occurs, reads out description information corresponding to the selected multimedia data from among description information stored in the storage unit and provides the description information to the output unit.

7. The apparatus as claimed in claim 1, wherein the pre-set event includes at least one of a first event where a command to reproduce the multimedia data is input, a second event where a predetermined time elapses while the multimedia data is being reproduced, and a third event where a command to confirm output of description information is input while the multimedia data is being output on the screen.

8. The apparatus as claimed in claim 1, wherein the controller controls the output unit to display a window which provides description information and allows a user to select a function to output the description information.

9. The apparatus as claimed in claim 1, wherein the controller outputs the description information in a form of sound data using text to speech (TTS) software.

10. A method for controlling a television apparatus, the method comprising:
receiving multimedia data from an external apparatus;
selecting the multimedia data provided by the external apparatus; and
if a pre-set event occurs, outputting description information regarding the selected multimedia data along with the multimedia data.

11. The method as claimed in claim 10, wherein the outputting the description information includes:
outputting the multimedia data on a screen; and
outputting the description information in a form of sound data.

12. The method as claimed in claim 10, wherein the outputting the description information includes:
outputting the multimedia data on a screen; and
forming the description information in a form of text and letting the description information be displayed and moved on the screen.

13. The method as claimed in claim 10, wherein the multimedia data is at least one of a photo or a video,
wherein the external apparatus is a Universal Serial Bus (USB) apparatus which is connected to the television apparatus or an image capturing apparatus which takes the photo data or the video data.

14. The method as claimed in claim 13, wherein the description information includes at least one of information regarding a place where the photo or the video was taken, the name of the photo data or the video data, and recorded information regarding the photo data or the video data.

15. The method as claimed in claim 10, further comprising:
storing a multimedia data list and description information regarding the multimedia data provided by the external apparatus after the multimedia data is selected,
wherein the outputting description information comprises, if at least one multimedia data is selected from the list, receiving the selected multimedia data from the external apparatus and outputting the multimedia data, and if the pre-set event occurs, reading out description information corresponding to the selected multimedia data from among the stored description information and outputting the description information.

16. The method as claimed in claim 10, wherein the pre-set event includes at least one of a first event where a command to reproduce the multimedia data is input, a second event where a predetermined time elapses while the multimedia data is being reproduced, and a third event where a command to confirm output of description information is input while the multimedia data is being output on the screen.

17. The method as claimed in claim 10, wherein the outputting description information comprises displaying a window which provides description information and allows a user to select a function to output the description information.

18. The method as claimed in claim 10, wherein the outputting description information comprises outputting the description information in a form of sound data using text to speech (TTS) software.
